(19) United States
(12) Patent Application Publication
(10) Pub. No.: US 2006/0209821 A1
(43) Pub. Date: Sep. 21, 2006

(54) Apparatus and method for selecting network interface in mobile terminal supporting multiple wireless access scheme

(75) Inventors: Heung-Chul Jung, Suwon-si (KR); Sung-Won Lee, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/376,420

(22) Filed: Mar. 16, 2006

(30) Foreign Application Priority Data
Mar. 16, 2005 (KR) 2005-21644

(51) Int. Cl. H04L 12/56

(52) U.S. Cl. 370/389; 709/250; 370/395.53

(57) ABSTRACT

An apparatus and method are provided for selecting a network interface in a mobile terminal supporting a multiple wireless access scheme. Upon receiving a connection request to a particular network interface from an application layer, an interface manager maps the application layer to its associated network interface. Upon detecting handoff by receiving current air information, a handoff manager transmits information indicating a change to a new network interface, to a virtual interface. The virtual interface transmits an Internet protocol (IP) packet received from the application layer to the exterior via the network interface mapped to the application layer according to the handoff decision result of the handoff manager.

### CROSS-REFERENCE TO RELATED APPLICATION

This application claims the benefit under 35 U.S.C. § 119(a) of a Korean patent application entitled “Apparatus and Method for Selecting Network Interface in Mobile Terminal Supporting Multiple Wireless Access Scheme”, filed in the Korean Intellectual Property Office on Mar. 16, 2005 and assigned Serial No. 2005-21644, the entire contents of which are hereby incorporated by reference.

### BACKGROUND OF THE INVENTION

1. Field of the Invention

The present invention relates generally to an apparatus and method for selecting a network interface in a mobile terminal. In particular, the present invention relates to an apparatus and method for selecting a network interface in a mobile terminal supporting a multiple wireless access scheme.

2. Description of the Related Art

In general, mobile communication networks for providing the conventional circuit-switched voice service comprises a Frequency Division Multiple Access (FDMA) network that divides a predetermined frequency band into a plurality of frequency channels and allocates the frequency channels to a plurality of subscribers, a Time Division Multiple Access (TDMA) network that divides a frequency channel into a plurality of time slots and allocates the time slots to a plurality of subscribers, and a Code Division Multiple Access (CMDA) network that allocates the same frequency band and the same time slot to a plurality of subscribers but allocates different codes to the subscribers, according to their communication methods.

With the rapid progress of communication technologies, the up-to-date CDMA communication system, which is the conventional mobile communication system, can provide not only the conventional voice service but also high-speed packet data service that allows subscribers to transmit large-volume digital data such as E-mails, still images, moving images, etc. with mobile terminals (or mobile stations).

A so-called 3^{rd} Generation (3G) mobile communication system for providing the high-speed packet data service generally employs the CDMA scheme, and the CDMA scheme comprises a synchronous scheme adopted in the United States and an asynchronous scheme adopted in Europe and Japan. For example, the asynchronous scheme comprises General Packet Radio Service (GPRS) and the synchronous scheme comprises CDMA 2000 1×, 1×Evolution Data Only (EV-DO), and 1×Evolution of Data and Voice (EV-DV). The mobile communication systems are now under active development, aiming at an International Mobile Telecommunication 2000 (IMT-2000) system, which is the synchronous next generation mobile communication system, and a Universal Mobile Telecommunication Systems (UMTS) system, which is the asynchronous next generation mobile communication system. The UMTS system is also known as a Wideband CDMA (W-CDMA) system.

A brief description of the mobile communication systems will now be made. GPRS has developed from circuit-switched Global System for Mobile communication (GSM) to provide packet data service, and CDMA 2000 1×provides data service at a downlink data rate of 144 Kbps which is greater than a data rate of the conventional IS-95A/IS-95B networks that support data rates of 14.4 Kbps and 56 Kbps, using an IS-95C network that has evolved from the conventional IS-95A/IS-95B networks. 1×EV-DO has evolved from CDMA 2000 1×to support a downlink data rate of about 2.4 Mbps, for transmission of large-volume digital data, and 1×EV-DV simultaneously supports voice and data services to make up for the defects of 1×EV-DO.

Meanwhile, the IEEE 802.1×standardization group is now establishing another standard for providing wireless Internet service to mobile terminals, and the network providing the wireless Internet service according to the IEEE 802.1×standard is commonly called a Wireless Local Area Network (WLAN). The WLAN, due to its broad transmission bandwidth, can transmit/receive a large volume of packet data through mobile terminals in a short time, and provides portable Internet service (also known as WiBro service) in which every subscriber shares channels to efficiently use the Broadband Wireless Access (BWA) network.

A scheme for providing the packet data service to the mobile terminals is roughly divided into a scheme using a 3G CDMA 2000 1×mobile communication network (hereinafter referred to as a “mobile communication network-based scheme”) and a scheme using a WLAN (hereinafter referred to as a “WLAN-based scheme”). In the mobile communication network-based scheme, after a Point-to-Point Protocol (PPP) session is set up between a mobile terminal and a packet data service node (PDSN), the PDSN allocates an IP address to the mobile terminal to provide the packet service. The WLAN-based scheme allocates an IP address to a mobile terminal accessing the WLAN via an Access Point (AP), using a Dynamic Host Configuration Protocol (DHCP). Thereafter, a Home Agent (HA) and a Foreign Agent (FA) cooperate to provide the packet service to the mobile terminal.

The packet data service based on the mobile communication network and the packet data service based on the WLAN independently operate as described above. Both networks, because they are connected to each other via an IP network such as the Internet, can simply provide network interworking service such as handoff service, using the existing network configuration and protocol configuration. The handoff service is provided to meet the user demands for the seamless packet data service and offer convenience to the service users, and there is an increasing demand for a study of the technology concerned.

With reference to FIG. 1, a description will now be made of a configuration of a conventional mobile communication system that provides handoff service.

FIG. 1 is a diagram illustrating a configuration of a conventional mobile communication system in which a mobile communication network and a WLAN are coupled to each other. For example, a CDMA 2000 1×network and an IEEE 802. 1×WLAN are coupled to each other.

Referring to FIG. 1, a mobile station (MS) 110 is connected to a mobile communication network via a base station (BS) 120, or connected to a WLAN via APs for connecting a wireless network to a wire network and an Access Point Controller (APC) for controlling packet communication (hereinafter referred to as “AP/APC” 150), to receive packet data service. The BS 120 comprises a Base Transceiver Subsystems (BTS) and a Base Station Controller (BSC) for controlling the BTSs. A Packet Control Function (PCF) 130 controls a flow of packet data between the BS 120 and a PDSN/FA 140.

The PDSN/FA 140 comprises a PDSN for processing PPP setup so that the MS 110 is connected to the PDSN, and an FA for managing a current IP address of the MS 110 in cooperation with an HA 170. Mobility of the MS 110 using the packet data service is guaranteed by well-known Mobile IP (MIP), and MIP supports the mobility by using two IP addresses for the MS 110. Of the two IP addresses, one is a home address that is fixed regardless of the current position of the MS 110, and the other is a Care-of-Address (CoA) that varies according to the current position of the MS 110. The home address and the CoA are handled by the HA 170 and the FA, respectively.

The PDSN/FA 140 serves as a gateway that establishes a PPP session to the MS 110 and then allows the MS 110 to exchange packet data with an undepicted Correspondent Node (CN). The CN refers to an application server that is connected to a packet data network such as an IP network and provides packet service to the MS 110. An Access Router (AR)/FA 160 comprises an AR for routing an access route of the MS 110 connected to the WLAN, and an FA for delivering packet data of the CN, received from the HA 170 using a Tunneling Protocol, to the current position, that is, CoA, of the MS 110, or delivering packet data of the MS 110 to the CN.

All packet data targeting the MS 110 is first delivered to the HA 170 in the IP network, which manages the fixed home address of the MS 110. The CN, which is an external host that exchanges packet data with the MS 110, is unaware of the CoA indicating the current position of the MS 110 and is aware of only the fixed home address of the MS 110. Therefore, the packet data targeting the MS 110 is first delivered to the FA of the PDSN/FA 140 or the FA of the AR/FA 160 via the HA 170 according to the network to which the MS 110 is currently connected, and then, transmitted to the MS 110 via the PDSN/FA 140 or the AR/FA 160.

In the foregoing network configuration in which the mobile communication network and the WLAN for packet service are interworking with each other, because the two networks operate separately, it is possible to enable interworking (that is, handoff) between the two networks using MIP without the change in the existing network configuration and protocol configuration.

FIG. 2 is a block diagram illustrating an internal structure of a conventional mobile terminal.

Referring to FIG. 2, a controller 200 controls the overall operation of the mobile terminal, comprising the call processing.

A display 210, under the control of the controller 200, displays display data for key input data received from a key input unit 220, or displays an operating state of the mobile terminal and various information using icons, Short Message Service (SMS) messages, and images. Further, the display 210, under the control of the controller 200, allows a subscriber to visually recognize an operating state when he/she sets or enables a necessary function. In addition, the display 210, under the control of the controller 200, displays a call processing-relayed screen, an SMS-related screen, and an Internet-related screen.

The key input unit 220, comprising a plurality of alphanumeric keys and function keys, provides key data input by the subscriber to the controller 200. That is, upon receiving a key input for each of the keys, the key input unit 220 outputs key input data unique to the corresponding key input, and the key input data output from the key input unit 220 is applied to the controller 200. The controller 200 determines to which key input the received key input data is mapped, and performs a corresponding operation according to the determination result.

A memory 230 connected to the controller 200 comprises a Read Only Memory (ROM) for storing various program information necessary for controlling an operation of the mobile terminal, a Random Access Memory (RAM), and a voice memory.

A radio frequency (RF) unit 250 exchanges RF signals with a BS via an antenna. The RF unit 250 down-converts a received RF signal into an intermediate frequency (IF) signal and outputs the IF signal to a baseband processor 240. The RF unit 250 up-converts an IF signal received from the baseband processor 240 into an RF signal and transmits the RF signal to the BS. The baseband processor 240 serves as a Baseband Analog ASIC (BAA) providing an interface between the controller 200 and the RF unit 250. The baseband processor 240 converts a baseband digital signal received from the controller 200 into an IF signal and applies the IF signal to the RF unit 250. The baseband processor 240 converts an analog IF signal received from the RF unit 250 into a baseband digital signal and applies the baseband digital signal to the controller 200.

A camera 260 is installed in the mobile terminal to realize a camera phone function. If a photography key input is received from the subscriber, the photography key input is conveyed to the controller 200 through the key input unit 220, and the controller 200 controls a photography function of the mobile terminal according to photography key input.

FIG. 3 is a diagram illustrating a protocol stack of a conventional mobile terminal.

Referring to FIG. 3, a mobile terminal 110, or a mobile station (MS), comprises hardwares 104 and 105 supporting Air and Medium Access Control (MAC), a kernel protocol stack 103 for handling an associated firmware and Layer 3 or higher, and application layers 100 through 102 comprising application programs (for example, voice call and download service application programs) for actually implementing services. The application layers 100 through 102 each send the kernel protocol stack 103 a connection request for using IP addresses and port numbers as network resources. Thereafter, the kernel protocol stack 103 maps an available one of the currently available network interfaces to its associated IP address and port number (IP address +port #), and exchanges traffics with the physical layers 104 and 105. The physical layers of the mobile terminal comprise a WLAN/BWA layer 104 accessable to a WLAN/BWA network, and a 3G MAC/Air layer 105 accessable to a mobile communication network.

FIG. 4 is a diagram for a description of a change in protocol stack when a conventional mobile terminal performs handoff. The left-hand side of FIG. 4 shows a configuration in which an application program performs communication by using wireless access technology for a WLAN or BWA network (hereinafter referred to as WLAN/BWA). The right-hand side of FIG. 4 shows a configuration in which an application program performs communication using wireless access technology for a mobile communication network when the mobile terminal moves from the WLAN/BWA network to the mobile communication network.

If the mobile terminal moves from the WLAN/BWA network to the mobile communication network, the mobile terminal can no longer perform communication with the WLAN/BWA network. In this case, because there is no change in the IP address and the port number, the application layers 411 through 413 cannot detect the change in network interface due to handoff.

In this configuration, the application programs cannot select and use the wireless access technology. Because the WLAN/BWA network has narrower coverage and a broader bandwidth and the mobile communication network has broader coverage and a narrower bandwidth, they are wireless access technologies that can make up for the defects of each other. In this case, the application programs can also be used according to such characteristics. For example, for Presence Service and Location Based Service (LBS), in which one party can be aware of state information of the other party, like VoIP and MSN messenger, there is no need to provide seamless service even though handoff occurs. However, in the case where a user using an application program that requires a broad bandwidth like File Transport Protocol (FTP) performs handoff from the WLAN/BWA network to the mobile communication network, if the user shares the narrow bandwidth of the mobile communication network to provide FTP and VoIP services, the real-time service suffers from abrupt deterioration in the quality as shown in FIG. 5. In addition, if the user receives the FTP service via the mobile communication network, the service charge increases dramatically because the mobile service charge is greater than the service change for the WLAN/BWA network. FIG. 5 is a diagram illustrating a bandwidth of a conventional mobile terminal supporting handoff service.

In an exemplary implementation in FIG. 5, an application program of a mobile terminal 110 may provide the FTP service having bulky traffic characteristics and the VoIP service having real-time characteristics. In FIG. 5, thickness of an arrow represents transmission bandwidth. That is, the thicker arrow represents the broader bandwidth, and the thinner arrow represents the narrower bandwidth.

In an exemplary implementation, the mobile terminal may have performed handoff from a hot spot zone to an outdoor zone where it cannot receive the WLAN/BWA service.

In FIG. 5, reference numerals 511 and 521 denote bandwidths required to receive the FTP service, and reference numerals 512 and 522 denote bandwidths required to receive the VoIP service.

A mobile terminal 510 in the hot spot zone can support the sufficient bandwidth as shown by reference numeral 513. However, if the mobile terminal 510 performs handoff from the hot spot zone to the outdoor zone, it cannot support the sufficient bandwidth as shown by reference numeral 523 because it has moved to the mobile communication network. Therefore, when the mobile terminal has performed handoff from the hot spot zone to the mobile communication network, the real-time service suffers from deterioration in the quality because of the contention between the real-time traffic and the bulky traffic.

### SUMMARY OF THE INVENTION

Therefore, an object of the present invention is to provide an apparatus and method for more efficiently providing wireless resources for each individual service without a change in application program during handoff in a mobile terminal for supporting a multiple wireless access scheme.

Another object of the present invention is to provide an apparatus and method for more efficiently coupling an application layer for providing a service to wireless access technologies having heterogeneous characteristics in a mobile terminal essentially simultaneously for supporting the wireless access technologies having the heterogeneous characteristics.

Further another object of the present invention is to provide an apparatus and method for allowing an application program that operates in a particular wireless access technology and an application program that requires an essentially seamless service to operate without modification in operation and structure in a mobile terminal for supporting a multiple wireless access scheme.

Yet another object of the present invention is to provide an apparatus and method for preferentially servicing an application program that requires a seamless service when a mobile terminal receiving a broad band service moves to a narrow band service.

Still another object of the present invention is to provide an apparatus and method for safely servicing an application program that requires a seamless service in an unstable state where handoff repeatedly occurs between a WLAN/BWA network and a mobile communication network in a short time.

According to an exemplary aspect of the present invention, a network interface apparatus of a mobile terminal for supporting a plurality of wireless access schemes having different characteristics is provided. The network interface apparatus comprises a first network interface for communicating with a first wireless communication system, a second network interface for communicating with a second wireless communication system, a virtual interface for communicating with the first wireless communication system or the second wireless communication system via the first network interface or the second network interface, and an interface manager for, upon receiving a connection request from a first application program communicable with one of the first network interface and the second network interface, mapping the first application program to a network interface satisfying a characteristic of the first application program among the first network interface and the second network interface, and upon receiving a connection request from a second application program communicable with both of the first network interface and the second network interface, mapping the second application program to the virtual interface.

According to an exemplary aspect of the present invention, a method for selecting a network interface of a mobile terminal is provided. The mobile terminal comprises a first network interface for communicating with a first wireless communication system and a second network interface for communication with a second wireless communication system, and supports a plurality of wireless access schemes having different characteristics. The method comprises upon receiving a connection request from a first application program communicable with one of the first network interface and the second network interface, mapping by an interface manager the first application program to a network interface satisfying a characteristic of the first application program among the first network interface and the second network interface, and upon receiving a connection request from a second application program communicable with both of the first network interface and the second network interface, mapping the second application program to a virtual interface, upon detecting handoff by receiving current air information, transmitting, by a handoff manager, information indicating a change to a new network interface, to the virtual interface, and transmitting, by the virtual interface, an Internet protocol (IP) packet to the exterior via the new network interface.

According to yet another exemplary aspect of the present invention, a method for selecting a network interface of a virtual interface in a mobile terminal is provided. The mobile terminal comprises a first network interface for communicating with a first wireless communication system and a second network interface for communication with a second wireless communication system, and supports a plurality of wireless access schemes having different characteristics. The method comprises upon detecting handoff by receiving current air information, transmitting, by a handoff manager, information indicating a change to a new network interface, to the virtual interface, and receiving, by the virtual interface, an Internet protocol (IP) packet from an application program communicable with both of the first network interface and the second network interface and transmitting the received IP packet to the exterior via the new network interface.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram illustrating a configuration of a conventional mobile communication system supporting handoff service;

FIG. 2 is a block diagram illustrating an internal structure of a conventional mobile terminal;

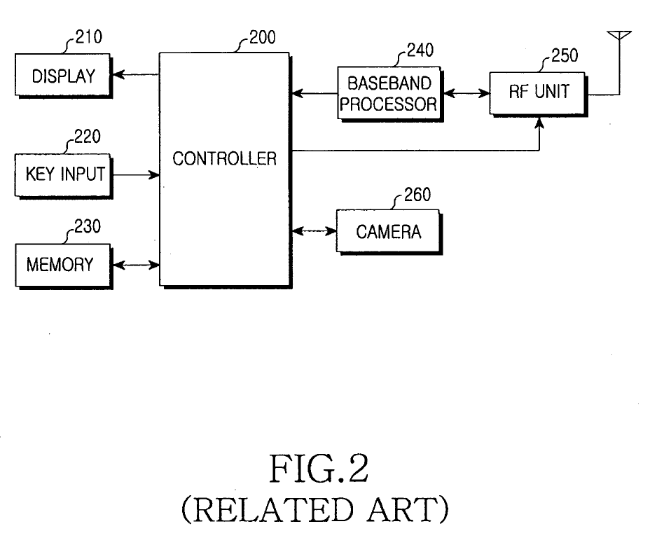

FIG. 3 is a diagram illustrating a protocol stack of a conventional mobile terminal;

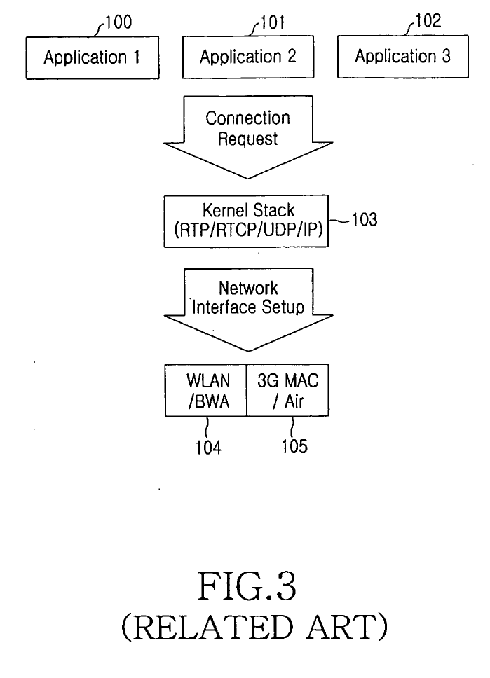

FIG. 4 is a diagram illustrating a protocol stack of a conventional mobile terminal for supporting handoff service;

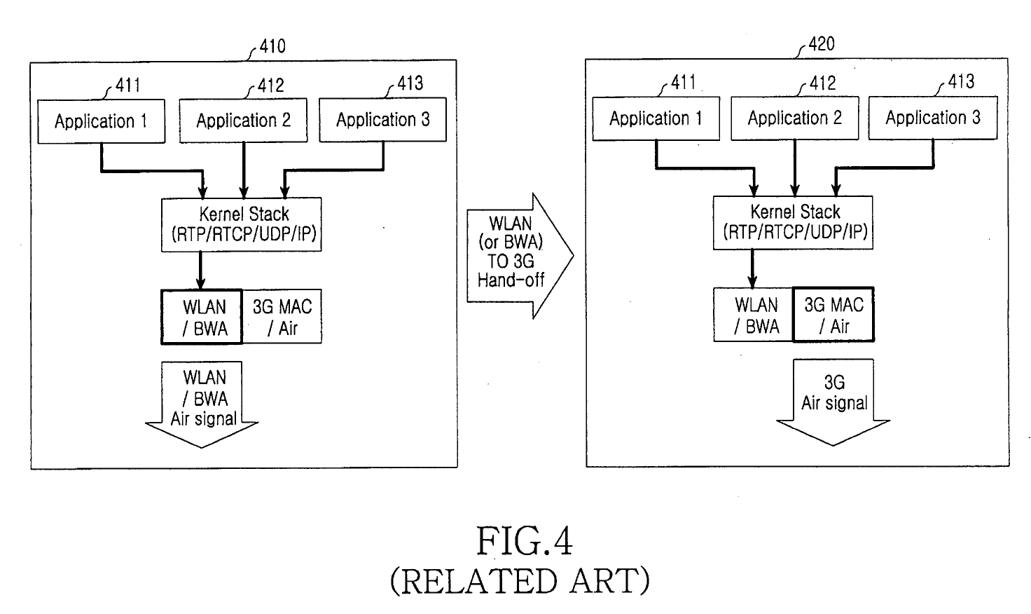

FIG. 5 is a diagram illustrating a bandwidth of a conventional mobile terminal for supporting handoff service;

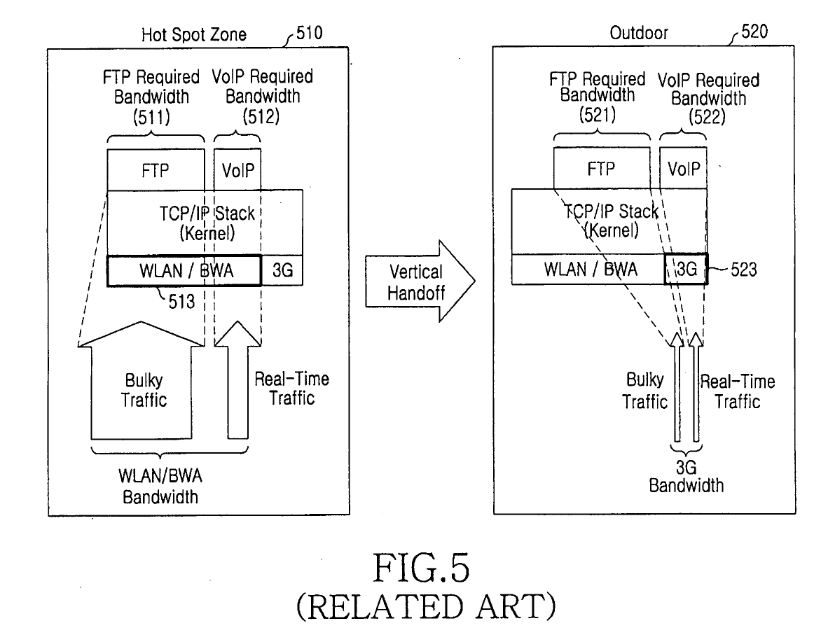

FIG. 6 is a block diagram illustrating an internal structure of a mobile terminal according to an exemplary embodiment of the present invention;

FIGS. 7A and 7B are block diagrams illustrating an initial operation of an application program that uses the air for only one of a WLAN/BWA network and a mobile communication network according to an exemplary embodiment of the present invention;

FIG. 8 is a diagram illustrating an internal structure of a mobile terminal operating in a WLAN/BWA network according to an exemplary embodiment of the present invention;

FIG. 9 is a diagram illustrating an internal structure of a mobile terminal after its handoff from a WLAN/BWA network to a mobile communication network according to an exemplary embodiment of the present invention;

FIG. 10 is a diagram illustrating a structure of a mobile terminal for performing communication via a mobile communication network after its handoff from a WLAN/BWA network to the mobile communication network according to an exemplary embodiment of the present invention;

FIG. 11 is a diagram illustrating a change in bandwidth when a network interface is selected according to an exemplary embodiment of the present invention; and

FIG. 12 is a flowchart illustrating a method for selecting a network interface in a mobile terminal supporting a multiple access scheme according to an exemplary embodiment of the present invention.

Throughout the drawings, like reference numerals will be understood to refer to like parts, components and structures.

### DETAILED DESCRIPTION OF EXEMPLARY EMBODIMENTS

Exemplary embodiments of the present invention will now be described in greater detail with reference to the annexed drawings. In the following description, a detailed description of known functions and configurations incorporated herein has been omitted for clarity and conciseness.

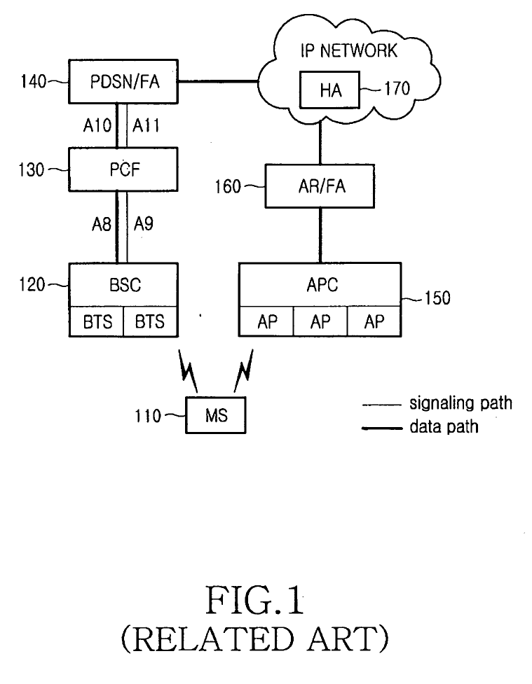

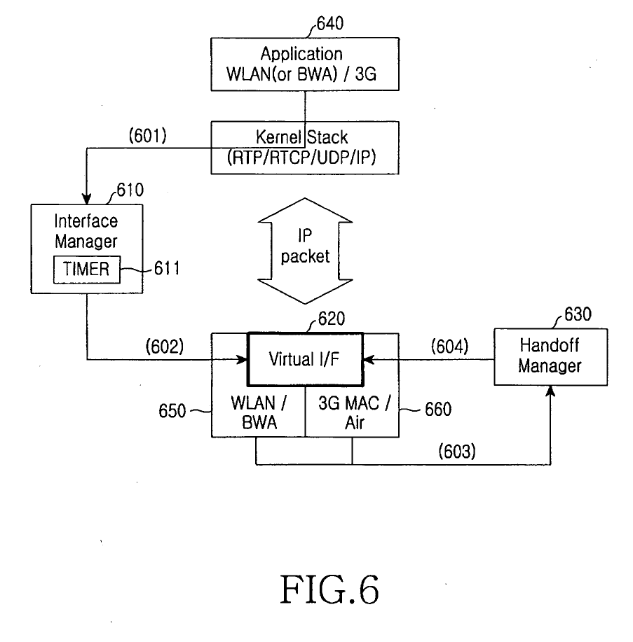

According to an exemplary implementation of the present invention, a mobile terminal that connects with an interface according to service characteristic is provided. FIG. 6 is a block diagram illustrating a structure of a mobile terminal according to an exemplary embodiment of the present invention. With reference to FIG. 6, a description will now be made of the mobile terminal according to an exemplary embodiment of the present invention. In FIG. 6, the same elements as those shown in FIG. 1 are denoted by the same reference numerals (notations).

In an exemplary implementation, a mobile terminal 110 may access a mobile communication network, a WLAN network, and a BWA network via a mobile communication network (or 3G) interface, a WLAN interface and a BWA interface, respectively.

The mobile terminal 110 comprises an interface manager 610 for allowing the mobile terminal 110 to connect with a network interface according to a service characteristic, a virtual interface 620 for seamless service, and a handoff manager 630 for performing handoff. Upon receiving a connection request for an application program from an application layer 640, the interface manager 610 maps the application program to its associated network interface, i.e., maps the application program to a WLAN/BWA interface and a mobile communication network (or 3G) interface. In this case, the interface manager 610 uses a network interface available for the mapping, an IP address, and a port number.

The interface manager 610 periodically monitors state information of the network interface. The interface manager 610 comprises a timer 611, and starts the timer 611 during handoff. After starting the timer 611, if the network interface is not activated to the previous state (i.e., if there is a change in the network interface) within a predetermined time, the interface manager 610 ends the application program that performs communication with the network interface. However, if the network interface is activated to the previous state (i.e., if there is no change in the network interface) within the predetermined time, the interface manager 610 re-enables (or restarts) the application program that performs communication with the network interface.

The virtual interface 620, as shown in FIG. 6, exists on a WLAN/BWA physical layer 650 and a mobile communication network (or 3G) MAC/Air layer 660, and hides a change in lower physical network interface from an upper layer. The virtual interface 620 periodically monitors state information of the network interface and transmits the state information of the network interface to the handoff manager 630. Further, the virtual interface 620 exchanges its own IP packets with a predetermined network interface based on handoff decision of the handoff manager 630.

The handoff manager 630 transmits/receives state information of the WLAN/BWA layer 650 and the 3G MAC/Air layer 660 via the virtual interface 620, determines whether to perform handoff based on the state information, and provides the handoff decision information to the virtual interface 620.

FIG. 6 is a block diagram illustrating an initial operation of an application program that simultaneously uses the WLAN/BWA network and the mobile communication network.

An application program of the application layer 640 that simultaneously uses the WLAN/BWA network and the mobile communication network sends a connection setup request to the interface manager 610 in step 601. Then the interface manager 610 classifies an application program supporting multiple wireless access technology with a port number. Thereafter, in step 602, the interface manager 610 exchanges traffics of the application program with the exterior via the virtual interface 620. The virtual interface 620 operates as an interface that virtually exists on the WLAN/BWA network and the mobile communication network, thereby hiding a change in lower physical layer, i.e., the WLAN/BWA layer 650 and the 3G MAC/Air layer 660, from the upper layer. In step 603, the physical layers 650 and 660 transmit the state information of the network interface to the handoff manager 630. Then the handoff manager 630 determines whether to perform handoff based on the received state information of the network interface. In step 604, the handoff manager 630 conveys the handoff decision result to the virtual interface 610. The traffics of the application layer conveyed to the virtual interface in this manner are transmitted to the exterior using any one of an interface for the WLAN/BWA layer 650 and an interface for the 3G MAC/Air layer 660.

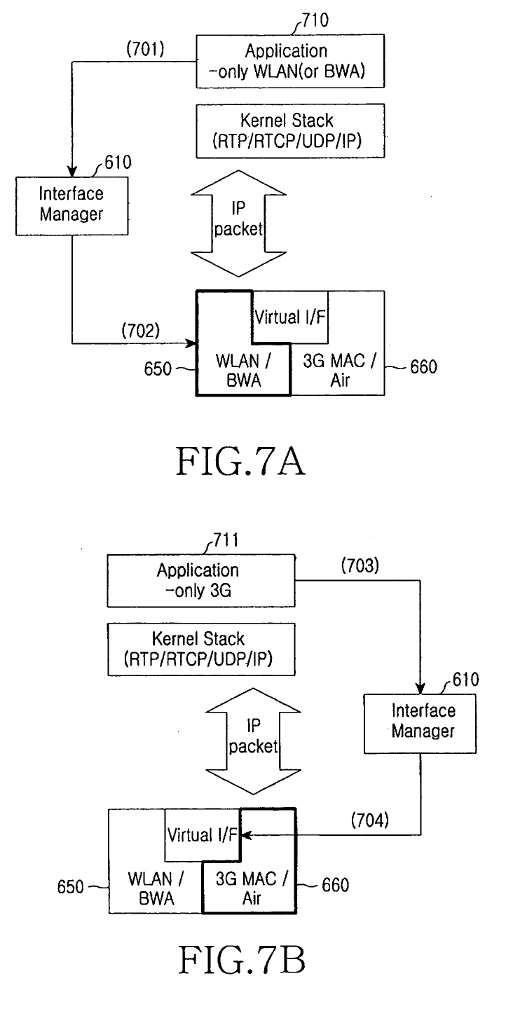

FIGS. 7A and 7B are block diagrams illustrating an initial operation of an application program that uses the air for only one of a WLAN/BWA network and a mobile communication network according to an exemplary embodiment of the present invention. Specifically, FIG. 7A illustrates an initial operation of an application program that use wireless portion of the WLAN/BWA network, and FIG. 7B illustrates an initial operation of an application program that uses only the air of the mobile communication network.

Referring to FIG. 7A, an application layer 710 that uses only the WLAN/BWA technology transmits a connection request to an interface manager 610 in step 701. Then the interface manager 610 maps an application program of the application layer 710 to a WLAN/BWA layer 650 using a port number in step 702.

Referring to FIG. 7B, an application layer 711 that uses only the mobile communication network (or 3G) technology transmits a connection request to an interface manager 610 in step 703. Then the interface manager 610 maps an application program of the application layer 711 to a 3G MAC/Air layer 660 using a port number in step 704.

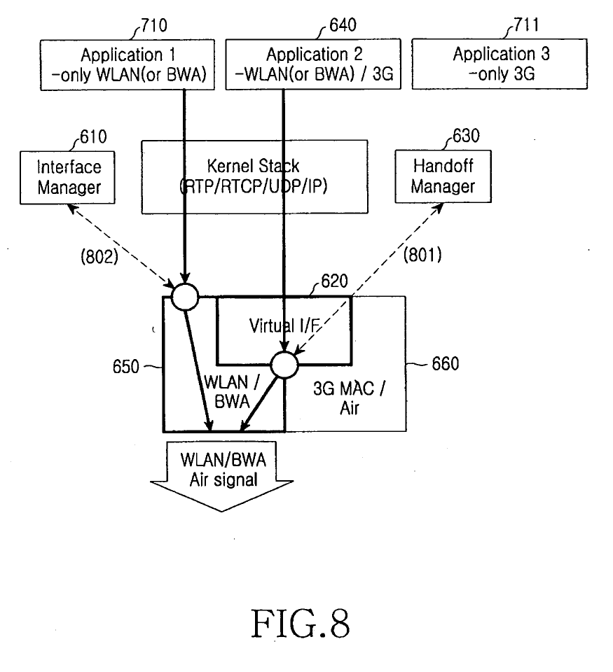

FIGS. 8 through 10 are diagrams for a description of a method for selecting a network interface during mobile terminal's handoff from a WLAN/BWA network to a mobile communication network.

FIG. 8 is a diagram illustrating an internal structure of a mobile terminal operating in a WLAN/BWA network according to an exemplary embodiment of the present invention.

Referring to FIG. 8, in step 801, a handoff manager 630 exchanges state information of a WLAN/BWA network and a mobile communication network with a virtual interface 620. In step 802, the interface manager 610 periodically monitors state information of a WLAN/BWA layer 650. The interface manager 610 maps an application program #2 of an application layer 640 that simultaneously provides WLAN/BWA service and mobile communication network (or 3G) service, to the virtual interface 620. As a result, traffics from the application program #2 of the application layer 640 are transmitted to the exterior via the virtual interface 620. That is, the traffics of the application layer 640, delivered to the virtual interface 620, are transmitted to the exterior using an interface for the WLAN/BWA layer 650 out of the interfaces for the WLAN/BWA layer 650 and the 3G MAC/Air layer 660. In addition, the interface manager 610 transmits traffics of an application program #1 of an application layer 710 that provides only the WLAN/BWA service, to the exterior via the interface for the WLAN/BWA layer 650.

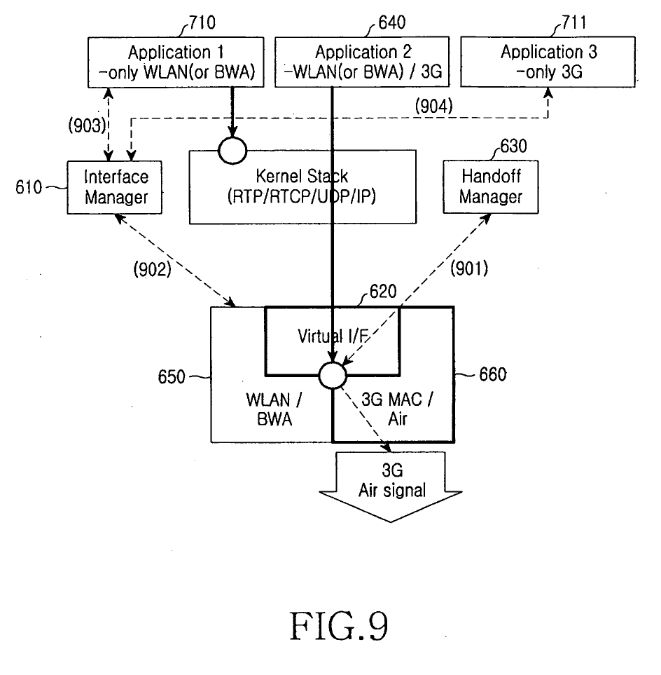

FIG. 9 is a diagram illustrating an internal structure of a mobile terminal after its handoff from a WLAN/BWA network to a mobile communication network according to an exemplary embodiment of the present invention.

Referring to FIG. 9, in step 901, a handoff manager 630 exchanges air state information of a WLAN/BWA network and a mobile communication network with a virtual interface 620. If the mobile terminal detects a need for handoff from the WLAN/BWA network to the mobile communication network, the handoff manager 630 determines to perform handoff and provides the handoff decision result to the virtual interface 620. Thereafter, in step 902, the interface manager 610 periodically monitors a state of a network interface. In the meantime, if handoff occurs, the interface manager 610 starts a timer 611 included therein. After starting the timer 611, if the network interface is not activated within a predetermined time, the interface manager 610 ends an application program #1 710 mapped to a WLAN/BWA interface thereby to pend the traffics in step 903. However, after starting the timer 611, if the network interface is activated within the predetermined time, the interface manager 610 re-enables the application program #1 710 mapped to the WLAN/BWA interface.

If the traffics are pended by ending in step 903 the application program #1 710 mapped to the WLAN/BWA interface, the application program #1 of the application layer 710 mapped to the WLAN/BWA interface can no longer perform communication. In step 904, the interface manager 610 transmits information indicating enablement of a mobile communication network interface to an application program #3 of an application layer 711 mapped only to the mobile communication network. If the application program #3 of the application layer 711 has previously transmitted a connection request to the interface manager 610, the interface manager 610 performs the connection operation.

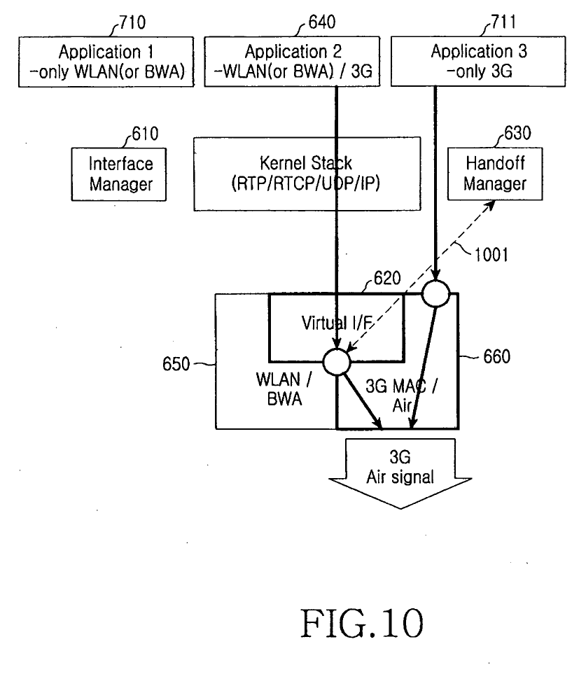

FIG. 10 is a diagram illustrating a structure of a mobile terminal for performing communication via a mobile communication network after its handoff from a WLAN/BWA network to the mobile communication network according to an exemplary embodiment of the present invention.

Referring to FIG. 10, in step 1001, a handoff manager 630 exchanges state information of a WLAN/BWA network and a mobile communication network with a virtual interface 620.

Because the mobile terminal has performed handoff from the WLAN/BWA network to the mobile communication network as described with reference to FIG. 9, an application program #2 of an application layer 640 that can perform communication in both the WLAN/BWA network and the mobile communication network conveys its traffics to the virtual interface 620, and the virtual interface 620 transmits the traffics to the exterior via a 3G MAC/Air layer 660. In addition, an application program #3 of an application layer 711 that can perform communication only in the mobile communication network transmits its traffics to the exterior via the 3G MAC/Air layer 660.

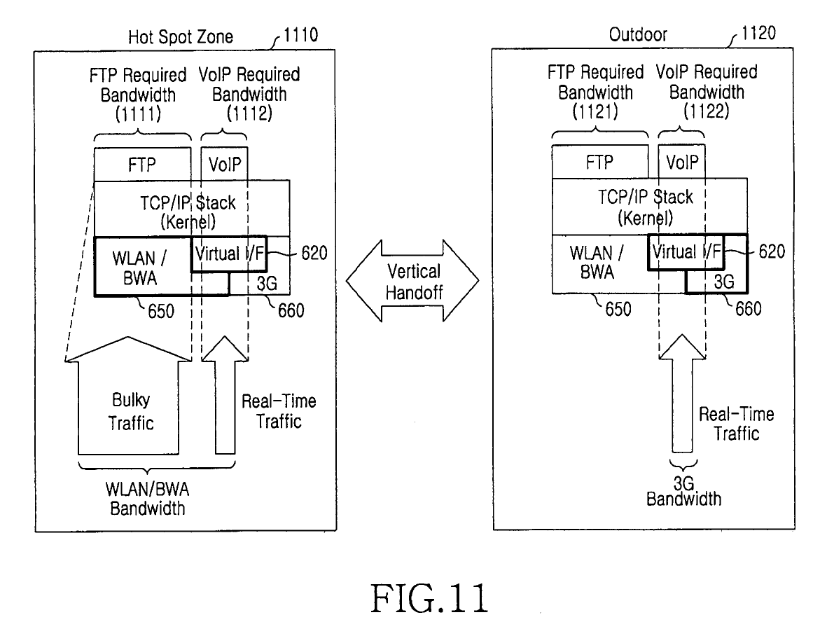

FIG. 11 is a diagram illustrating a change in bandwidth when a network interface is selected according to an exemplary embodiment of the present invention.

In exemplary implementation in FIG. 11, an application program of a mobile terminal 110 may provide FTP service having bulky traffic characteristics and VoIP service having real-time characteristics. In FIG. 11, thickness of an arrow represents transmission bandwidth. That is, the thicker arrow represents the broader bandwidth, and the thinner arrow represents the narrower bandwidth.

A virtual interface 620 exists on a WLAN/BWA layer 650 and a 3G MAC/Air layer 660.

In exemplary implementation, the mobile terminal 110 may have performed handoff from a hot spot zone 1110 to an outdoor zone 1120 where it cannot receive the WLAN/BWA service.

In FIG. 11, reference numerals 1111 and 1121 denote bandwidths required to receive the FTP service, and reference numerals 1112 and 1122 denote bandwidths required to receive the VoIP service.

The mobile terminal 110 in the hot spot zone 1110 can support the bandwidth sufficient to provide the FTP and VoIP services as shown by reference numerals 650 and 660. Even when the mobile terminal 110 performs handoff from the hot spot zone 1110 to the outdoor zone 1120, the mobile terminal 110 does not have an insufficient bandwidth because it has a bandwidth provided by the virtual interface 620 in addition to the bandwidth shown be reference numeral 660 after the handoff to the mobile communication network. Therefore, even though the mobile terminal 110 performs handoff from the hot spot zone 1110 to the outdoor zone 1120 where the mobile communication network is installed, the mobile terminal 110 can prevent the real-time service from suffering from deterioration in the quality due to the contention between the real-time traffic and the bulky traffic.

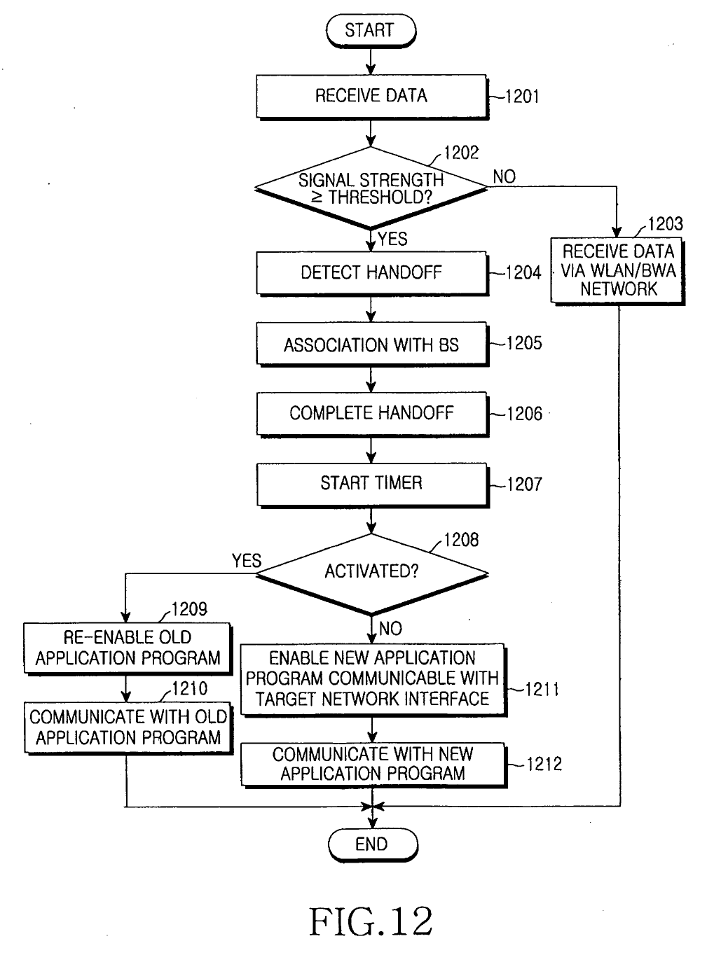

FIG. 12 is a flowchart illustrating a control operation of a mobile terminal according to an exemplary embodiment of the present invention. In an exemplary implementation herein, a mobile terminal 110 may be connected to a WLAN/BWA network.

Referring to FIG. 12, a mobile terminal 110 receives data via an AP (not shown) in step 1201. The mobile terminal determines in step 1202 whether strength of a signal from the AP is greater than or equal to a threshold. If the signal strength from the AP is not greater than or equal to the threshold, the mobile terminal 110 receives data via a WLAN/BWA network in step 1203. However, if the signal strength from the AP is greater than or equal to the threshold, a handoff manager 630 of the mobile terminal 110 detects handoff through an air signal in step 1204. Thereafter, the mobile terminal 110 performs association (or negotiation) with its nearest base station (BS) 120 to access a mobile communication network in step 1205, and completes handoff from the WLAN/BWA network to the mobile communication network in step 1206. At this moment, an interface manager 610 of the mobile terminal 110 monitors state information of a WLAN/BWA layer 650. Upon detecting the completion of the handoff, the interface manager 610 pends traffics, determining that it can no longer perform communication with an application program #1. At the same time, the interface manager 610 starts its timer 611 in step 1207. After starting the timer 611, the interface manager 610 determines in step 1208 whether its network interface is activated to the original network interface within a predetermined time. If its network interface is activated to the original network interface within the predetermined time, the interface manager 610 re-enables the old application program #1 in step 1209, and performs communication with the application program #1 in step 1210. However, if its network interface is not activated to the original network interface within the predetermined time in step 1208, the interface manager 610 enables in step 1211 any available application program, for example, an application program #3, communicable with a target network interface to which the mobile terminal 110 is handed off. Thereafter, the interface manager 610 maps the application program #3 to a 3G MAC/Air interface 660 to perform communication in step 1212. In addition, the interface manager 610 maps an application program #2 of an application layer 640 to a virtual interface 620 to perform communication.

As can be understood from the foregoing description, the mobile terminal supporting multiple wireless access technology can allow an application program that operates only in particular wireless access technology and an application program that requires seamless service during handoff to operate without modification in operation and structure.

In addition, the mobile terminal according to an exemplary embodiment of the present invention can preferentially service an application program that requires a seamless service when the mobile terminal receiving a broad band service moves to a narrow band service.

Further, in the mobile terminal with multiple wireless access technology according to an exemplary embodiment of the present invention, an application program that operates only in particular wireless access technology and an application program that requires seamless service can operate without modification in operation and structure.

Moreover, the present invention can safely service an application program that requires seamless service in an unstable state where handoff repeatedly occurs between a WLAN/BWA network and a mobile communication network in a short time.

While the invention has been shown and described with reference to a certain exemplary embodiment thereof, it will be understood by those skilled in the art that various changes in form and details may be made therein without departing from the spirit and scope of the invention as defined by the appended claims and their equivalents.

What is claimed is:

1. A network interface apparatus of a mobile terminal, comprising:
a first network interface for communicating with a first wireless communication system;
a second network interface for communicating with a second wireless communication system;
a virtual interface for communicating with at least one of the first wireless communication system and the second wireless communication system via at least one of the first network interface and the second network interface; and
an interface manager for, upon receiving a connection request from a first application program applicable to at least one of the first network interface and the second network interface, mapping the first application program to a network interface satisfying a characteristic of the first application program among at least one of the first network interface and the second network interface, and upon receiving a connection request from a second application program applicable to the first network interface and the second network interface, mapping the second application program to the virtual interface.

2. The network interface apparatus of claim 1, further comprising a handoff manager for, upon detecting handoff by receiving current air information, transmitting information indicating a change to a new network interface, to the virtual interface.

3. The network interface apparatus of claim 1, wherein the interface manager comprises a timer, and wherein, if the network interface is not activated to an old network interface within a time period, the interface manager enables an application program applicable to a new network interface and maps the application program to the new network interface.

4. The network interface apparatus of claim 1, wherein the interface manager comprises a timer, and wherein, if the network interface is not activated to an old network interface within a time period, the interface manager disables an application program applicable to the old network interface.

5. The network interface apparatus of claim 1, wherein the interface manager comprises a timer, and wherein, if the network interface is activated to an old network interface within a time period, the interface manager re-enables an old application program and maps the old application program to the old network interface.

6. The network interface apparatus of claim 1, wherein the interface manager maps an application program to a network interface satisfying a characteristic of the application program using a port number.

7. The network interface apparatus of claim 1, wherein at least one of the first network interface and the second network interface comprises the virtual interface.

8. The network interface apparatus of claim 1, wherein the virtual interface hides a change in the network interface from an upper layer.

9. The network interface apparatus of claim 1, wherein the interface manager periodically monitors a state of the network interfaces.

10. A method for selecting a network interface of a mobile terminal comprising a first network interface for communicating with a first wireless communication system and a second network interface for communication with a second wireless communication system, the method comprising the steps of:
upon receiving a connection request from a first application program applicable to at least one of the first network interface and the second network interface, mapping by an interface manager the first application program to a network interface satisfying a characteristic of the first application program among the first network interface and the second network interface, and upon receiving a connection request from a second application program applicable to both of the first network interface and the second network interface, mapping the second application program to a virtual interface;
upon detecting handoff by receiving current air information, transmitting, by a handoff manager, information indicating a change to a new network interface, to the virtual interface; and
transmitting, by the virtual interface, an Internet protocol (IP) packet via the new network interface.

11. The method of claim 10, further comprising the steps of:
if the network interface is not activated to an old network interface within a time period, enabling, by the interface manager, an application program applicable to the new network interface; and
mapping the application program to the new network interface.

12. The method of claim 10, further comprising the steps of:
if the network interface is activated to an old network interface within a time period, re-enabling, by the interface manager, an old application program and;
mapping the old application program to the old network interface.

13. The method of claim 10, wherein the mapping step comprises the step of mapping an application program to a network interface for satisfying a characteristic of the application program using a port number.

14. The method of claim 10, wherein at least one of the network interfaces comprises the virtual interface.

15. The method of claim 10, wherein the virtual interface hides a change in the network interface from an upper layer.

16. The method of claim 10, further comprising the step of periodically monitoring a state of the network interface by the interface manager.

17. A method for selecting a network interface of a virtual interface in a mobile terminal comprising a first network interface for communicating with a first wireless communication system and a second network interface for communication with a second wireless communication system, the method comprising the steps of:
upon detecting handoff by receiving current air information, transmitting, by a handoff manager, information indicating a change to a new network interface, to the virtual interface; and
receiving, by the virtual interface, an Internet protocol (IP) packet from an application program communicable with the first network interface and the second network interface and transmitting the received IP packet via the new network interface.

18. The method of claim 17, wherein at least one of the network interfaces comprises the virtual interface.

19. The method of claim 17, wherein the virtual interface hides a change in the network interface from an upper layer.
